(19) United States
(12) Patent Application Publication
(10) Pub. No.: US 2006/0131771 A1
(43) Pub. Date: Jun. 22, 2006

(54) Quality assurance method for coated parts

(76) Inventors: Douglas McBain, Wadsworth, OH (US); Elliott Straus, Akron, OH (US); John Thompson, Wooster, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/534,219

(22) PCT Filed: Nov. 5, 2003
(86) PCT No.: PCT/US03/35366

§ 371 Date: Nov. 15, 2005

(30) Foreign Application Priority Data
Nov. 8, 2002 (US) 60424866

(51) Int. Cl. B29C 45/76; B05C 5/00

(52) U.S. Cl. 264/40.1; 427/445

(57) ABSTRACT

A quality assurance method for in-mold coating of molded articles in which coated articles produced with one set of molding and coating process variables are inspected and changes are made to one or more of the variables based on the observations. Changes to one or more such variables based on the observations aid in producing subsequent coated articles of consistently high quality.

### BACKGROUND OF THE INVENTION

The present invention relates to a quality assurance method for parts produced from in-mold coating (IMC) a molded article, particularly to a method for improving the quality of a coated molded part by adjusting the molding and coating parameters based on previously produced parts.

Molded thermoplastic and thermoset articles are utilized in numerous applications in, e.g., the automotive, marine, recreation, construction, office products, and outdoor equipment industries. Often, application of a surface coating to such molded articles is desirable. For example, molded articles may be used as a part in multi-part assemblies; to match the finish of the other parts in such assemblies, the molded articles may require application of a surface coating that has the same finish properties as the other parts. Coatings may also be used to improve surface properties such as uniformity of appearance, gloss, scratch resistance, chemical resistance, weatherability, and the like. Also, surface coatings may be used to facilitate adhesion between a molded article and a separate finish coat to be later applied thereto.

Numerous techniques to apply surface coatings to molded articles have been developed. Many involve applying a surface coating to molded articles after they are removed from their molds. These are often multi-step processes involving surface preparation followed by spray-coating the prepared surface with paint or other finishes. In contrast, IMC provides a means of applying a surface coating to a molded article prior to its ejection from the mold.

Various methods have been used to apply coatings to molded thermoset and thermoplastic articles. For example, the IMC material can be sprayed onto the surface of an open mold prior to the molding process. However, spray coating can be time-consuming and, when the coating is applied using a volatile organic carrier, may require the use of containment systems.

Another IMC process involves lining a mold with a preformed film of coating prior to molding. The drawback of this process is that, on a commercial scale, it can be cumbersome and costly.

Yet another process involves a fluid coating composition injected onto and dispersed over the surface of a molded part and cured. A common method of injecting a coating composition onto the surface of a molded article involves curing (if a thermoset material) and cooling an article in the mold to the point that it has hardened sufficiently to accept the coating, reducing the pressure against the telescoping mold half to crack open or part the mold, injecting the fluid coating, and re-pressurizing the mold to distribute the coating over the surface of the molded article. The cracking or parting of the mold involves releasing the pressure exerted on the telescoping mold half to sufficiently move it away from the molded article, thereby creating a gap between the surface of the part and the telescoping mold half. The gap allows coating to be injected onto the surface of the part without needing to remove the part from the mold.

Injection molding requires that pressure on the movable mold half be maintained so as to keep the cavity closed and to prevent resin from escaping along the parting line. Further, maintaining pressure on the resin material during molding often is necessary to assist in providing a more uniform crystalline or molecular structure in the molded article. Without such packing, physical properties of the molded article tend to be impaired.

In addition to the problem of resin escaping along a parting line, packing constraints can create other problems when an IMC composition is to be injected into an injection mold containing a molded article. Specifically, some coating compositions cure thermally, often through transfer of residual heat from the molded article. Were the coating composition to be injected after a molded article has been sufficiently packed to allow the mold to be depressurized and parted or cracked, the molded article may lack sufficient residual heat to cure the coating. Thus, for coating compositions designed to cure on an article, they desirably are injected prior to depressurizing the mold.

Because injection molding does not permit the mold to be parted prior to injection of the IMC composition into the mold cavity, the IMC composition must be injected under sufficient pressure to compress the article in all areas to be coated. The compressibility of the molded article dictates how and where the IMC composition covers it. The process of coating an injection molded article with a liquid IMC composition is described in, for example, U.S. Pat. No. 6,617,033 and U.S. Patent Publication Nos. 2002/0039656 A1 and 2003/0082344 A1.

Several parameters must be monitored and controlled to ensure acceptable part performance and appearance when coating an injection molded article. These considerations include, without limitation, the amount of coating composition to be injected into the cavity, the precise timing of when to inject the coating composition into the cavity relative to the molding process, the force (clamping pressure) necessary to avoid leakage, and the injection point location of the coating composition to minimize trapped air and ensure adequate flow over the substrate. All of these parameters may affect the performance and appearance of the finished article. Varying each of these parameters either alone or in various combinations may affect the quality of the finished product.

To ensure the quality of the appearance and performance of the finished product, a method for efficiently modifying these parameters to optimal values based on inspection of finished parts is needed.

### SUMMARY OF THE INVENTION

Briefly, the present invention provides a method for assuring that coated molded articles meet predetermined quality standards. The articles are formed entirely in a mold by a process that includes forming a substrate from a first composition using a first set of process conditions and subsequently, using a second set of process conditions, coating the substrate by injecting a coating composition into the mold and allowing it to cure on the substrate so as to provide a coated molded article. The method involves inspecting a first coated molded article manufactured by the process after the article is removed from the mold; determining whether the coated molded article meets quality standards for substrate formation and, if not, modifying the substrate formation step of the process by adjusting one or more of first composition injection volume, first composition injection temperature, first composition injection pressure, and substrate molding pressure; and determining whether the coated molded article meets quality standards for coating and, if not, modifying the coating step of the process by adjusting one or more of cure time, injection time, injection pressure, injection volume, injection temperature, and mold temperature at injection of the coating composition. The volume of the mold optionally can be maintained constant throughout the molding and coating process.

### BRIEF DESCRIPTION OF THE DRAWINGS

The drawings are only for purposes of illustrating certain embodiments of, and are not to be construed as limiting, the invention.

FIG. 1 is a side view of a molding apparatus having a movable mold half and a stationary mold half suitable for use in one embodiment of the present invention.

FIG. 2 is a partial cross-sectional view of the molding apparatus of FIG. 1 showing the movable mold half and the stationary mold half wherein the movable mold half is in a closed position to form a mold cavity, which includes orifices for receiving first and second composition injectors.

FIG. 3 is a perspective view of one embodiment of an IMC dispense and control apparatus adapted to be connected to the molding apparatus of FIG. 1, FIG. 4 is a flowchart of the process steps in one embodiment of the present invention.

### DETAILED DESCRIPTION OF ILLUSTRATIVE EMBODIMENTS

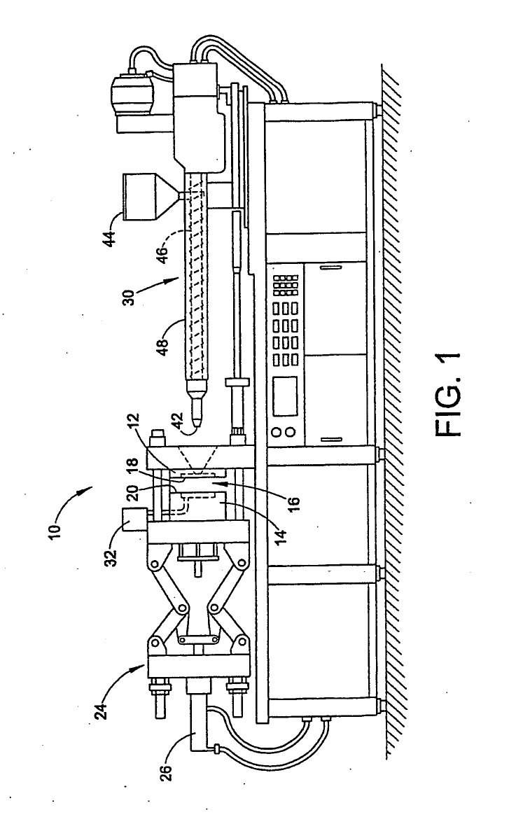

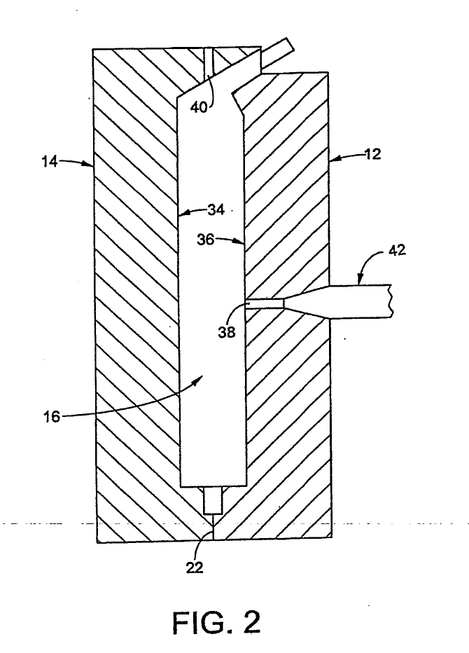

Referring now to the drawings wherein like reference characters represent like elements and which illustrate certain embodiments of the invention, FIG. 1 shows a molding apparatus or injection molding machine 10, which includes a first mold half 12 which preferably remains in a stationary or fixed position relative to a second moveable mold half 14. FIG. 1 shows movable mold half 14 in an open position. First mold half 12 and second mold half 14 are adapted to mate with one another to form a contained mold cavity 16 therebetween (See FIG. 2). Mold halves 12,14 mate along surfaces 18 and 20 (FIG. 1) when the molding apparatus is in the closed position, forming a parting line 42 (FIG. 2) therebetween and around mold cavity 16.

Movable mold half 14 reciprocates generally along a horizontal axis relative to mold half 12 by action of clamping mechanism 24 with clamp actuator 26 such as through a hydraulic, pneumatic or mechanical actuator as known in the art. Preferably, the clamping pressure exerted by clamping mechanism 24 should be capable of generating an operating pressure in excess of the pressures generated or exerted by either one of first composition injector 30 and second composition injector 32. For example, pressure exerted by clamping mechanism 24 can range generally from 14 MPa (about 2,000 psi) to about 103 MPa (about 15,000 psi), preferably from about 27 MPa (about 4,000 psi) to about 83 MPa (about 12,000 psi), and more preferably from about 41 MPa (about 6,000 psi) to about 69 MPa (about 10,000 psi) of the mold surface.

In FIG. 2, mold halves 12,14 are shown in a closed position abutting or mating with one another along parting line 42 to form mold cavity 16. The design of cavity 16 can vary greatly in size and shape according to the desired end product or article to be molded. Mold cavity 16 generally has a first surface 34 on the second mold half 14 and a corresponding or opposite second surface 36 on the first mold half 12. Mold cavity 16 also contains separate orifices 38,40 to allow composition injectors 30,32 to inject their respective compositions.

First composition injector 30 is that which is typical in an injection molding apparatus and is generally capable of injecting a thermoplastic or thermosetting composition, generally a resin or polymer, into mold cavity 16. Owing to space constraints, first injector 30 used to inject article-forming composition is positioned to inject material from fixed mold half 12, although first composition injector 30 could be reversed and placed in movable mold half 14. Second composition injector 32 is capable of injecting an IMC composition into mold cavity 16 to coat the molded article formed therein, although second composition injector 32 alternatively could be positioned in mold half 12.

In FIG. 1, first composition injector 30 is shown in a “backed off” position, but the same can be moved in a horizontal direction so that a nozzle or resin outlet 42 of first injector 30 mates with mold half 12. In the mated position, injector 30 is capable of injecting its contents into mold cavity 16. For purposes of illustration only, first composition injector 30 is shown as a reciprocating-screw machine wherein a first composition can be placed in hopper 44 and rotating screw 46 can move the composition through heated extruder barrel 48, where first composition or material is heated above its melting point. As the heated material collects near the end of barrel 48, screw 46 acts as an injection ram and forces the material through nozzle 42 and into mold cavity 16. Nozzle 42 generally has a valve (not shown) at the open end thereof and screw 46 generally has a non-return valve (not shown) to prevent backflow of material into screw 46.

First composition injector 30 is not meant to be limited to the embodiment shown in FIG. 1 but can be any apparatus capable of injecting a flowable (e.g., thermoplastic or thermosetting) composition into mold cavity 16. For example, the injection molding machine can have a mold half movable in a vertical direction such as in a “stack-mold” with center injection. Other suitable injection molding machines include many of those available from Cincinnati-Milacron, Inc. (Cincinnati, Ohio), Battenfeld Injection Molding Technology (Meinlerzhagen, Germany), Engel Machinery Inc. (York, Pa.), Husky Injection Molding Systems Ltd. (Bolton, Canada), BOY Machines Inc. (Exton, Pa.), etc.

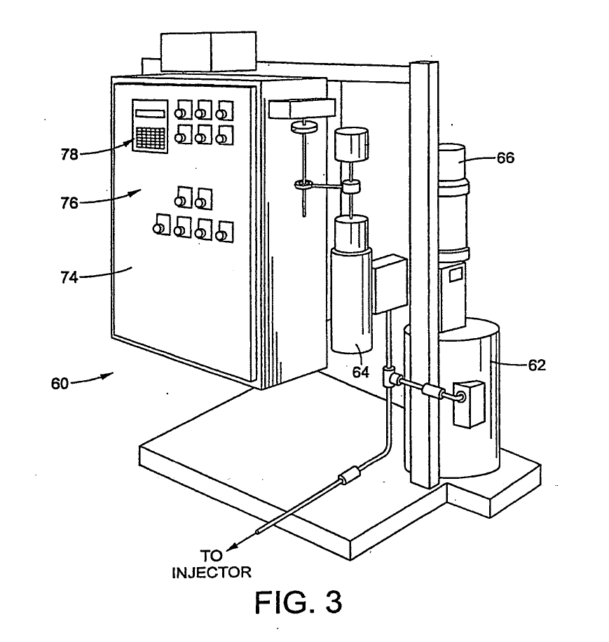

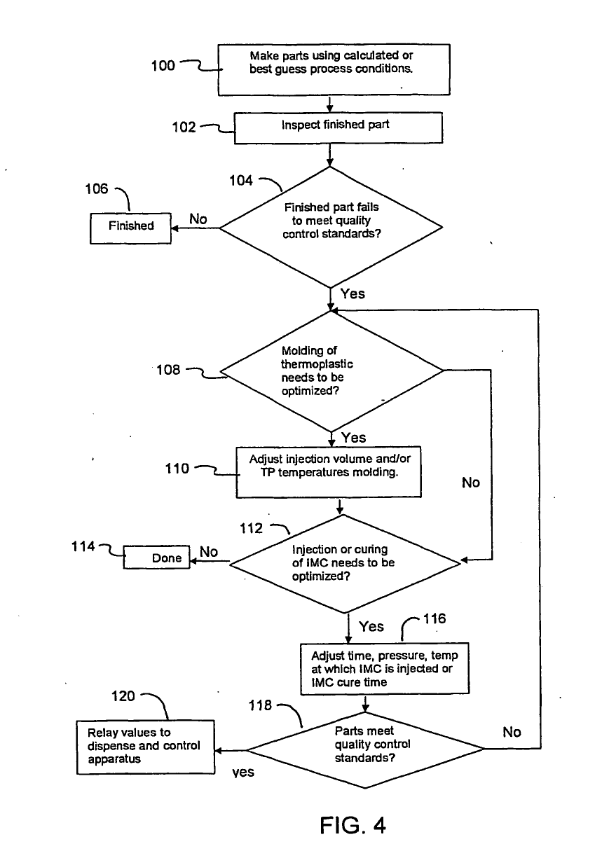

FIG. 3 shows an IMC dispense and control apparatus 80 adapted to be connected to molding apparatus 10 and provide IMC capabilities and controls therefor to the molding apparatus. Control apparatus 80 includes an IMC container receiving cylinder 82 for holding an IMC container such as a vat of an IMC composition. Suitable IMC compositions include those disclosed in U.S. Pat. No. 5,777,053. Control apparatus 80 further includes a metering cylinder or tube 84 that is adapted to be in fluid communication with the IMC container when received in the receiving cylinder 82. A transfer pump 86 is provided on control apparatus 80 and is capable of pumping IMC composition from receiving container 82 to metering cylinder 84.

Metering cylinder 84 is selectively fluidly connectable to second injector 32 on molding apparatus 10. Metering cylinder 84 includes a hydraulic means such as a piston for evacuating IMC composition-from metering cylinder 84 and directing it to second injector 32. A return line (not shown) is connected to second injector 32 and to receiving container 82 to fluidly communicate therebetween.

Control apparatus 80 further includes an electrical box 94 capable of being connected to a power source. Electrical box 94 includes a plurality of controls 96 and a touch pad or other type of controller 98 thereon for controlling the dispensing of IMC composition to mold cavity 16. A compressed air connector (not shown) is provided the control apparatus 80 for connecting apparatus 80 to a conventional compressed air line. Compressed air is used to drive transfer pump 86 and remove IMC from control apparatus 80 and its fluid communication lines during a cleaning operation. Additionally, air can be used to move solvent through the communication lines for cleaning purposes.

Dispense and control apparatus 80 may include a remote transmitter (not shown) adapted to be positioned, in preferred embodiment, on one of mold halves 12,14. The transmitter may be, for example, a conventional rocker switch that sends a signal to apparatus 80 upon actuation. The transmitter may be positioned on one of mold halves 12,14 such that it is actuated upon closure of mold halves 12,14. The signal sent from the transmitter is used to initiate a timer (not shown) on control apparatus 80.

Alternatively, molding apparatus 10 may be equipped with a transmitter or transmitting means that has the ability to generate a signal upon closure of mold halves 12,14. A conventional signal transfer cable can be connected between molding apparatus 10 and control apparatus 80 for communicating the signal to control apparatus 80. Such an arrangement eliminates the need for an independent transmitter to be connected to one of mold halves 12,14.

Alternatively or in addition to the transmitter, control apparatus 80 may include at least one remote sensor (not shown) adapted to be positioned on one of mold halves 12,14 or otherwise adjacent to mold cavity 16 to measure the pressure and/or temperature within mold cavity 16. This sensor can be any known type of such sensor including, for example, a pressure transducer, thermocouple, etc. The sensor(s) and control apparatus 80 are operatively connected via conventional means to allow measurement signals to pass therebetween.

To prepare for injection of IMC composition into the mold cavity, a container of an IMC composition is placed in receiving cylinder 82. Metering cylinder 84 is fluidly connected to second injector 32. Return line 88 is fluidly connected to second injector 32 and receiving cylinder 82. The control apparatus 80 is connected to a suitable power source such as a conventional 460 volt AC or DC electrical outlet to provide power to electrical box 94. The remote sensor is appropriately positioned on one of mold halves 12,14 as described above.

To make an in-mold coated article, with reference to FIG. 1, a first composition is placed in the hopper 44 of the molding apparatus 10. First injector 30 is moved into nesting or mating relation with fixed mold half 12. Through conventional means, i.e., using heated extruder barrel 48 and rotating screw 46, first injector 30 heats the first composition above its melting point and directs the heated first composition toward nozzle 42 of first injector 30. Mold halves 12,14 are closed thereby creating mold cavity 16. The transmitter, if present, is positioned on one of mold halves 12,14 such that, when they are closed, the transmitter sends a signal to control apparatus 80 indicating that mold halves 12,14 are closed and that the molding process has begun. Upon receipt of this signal, hereinafter referred to as T₀, dispense and control apparatus 80 initiates the timer contained therein, which tracks elapsed time from To. At predetermined elapsed time intervals, control apparatus 80 actuates and controls various IMC related functions to ensure that the IMC composition is delivered to mold cavity 16 at a desired point in the molding process. Thus, control apparatus 80 operates concomitantly with molding apparatus 10.

After T₀, the molding process continues and a nozzle valve (not shown) of nozzle 42 is moved to an open position for a predetermined amount of time to allow a corresponding quantity of the first thermoplastic composition to enter mold cavity 16 through orifice 38. Screw 46 provides a force or pressure that urges the first composition into mold cavity 16 until the nozzle valve returns to its closed position. Once mold cavity 16 is filled and packed, the first composition is allowed to cool to a temperature below its melting point. The first composition does not cool uniformly, with the material that constitutes the interior of the molded article generally remaining molten while the material that constitutes the surface begins to harden as it cools more quickly.

After injection, the resin in mold cavity 16 begins to solidify, at least to an extent such that the substrate can withstand injection and/or flow pressure subsequently created by introduction of the coating composition. During this solidification, the forming article cools somewhat, and this is believed to result in at least a slight shrinkage, i.e., a small gap between the forming article and surfaces 34 and 36. Clearly, some type of active movement of surfaces 34 and 36 from the forming article could be undertaken but has not proven necessary. A predetermined amount of coating composition is utilized so as to provide a coating having, for example, a desired thickness and density.

As described above, allowing the surface of the substrate to sufficiently cool and harden such that the IMC composition and the first composition do not excessively intermingle. Also, the longer the time period between the end of the first composition filling and the coating injection, generally the lower the packing pressure needed to inject the coating composition and the easier the injection. However, because the IMC composition generally relies on the residual heat of the cooling article to cure, one risks inadequate curing of the IMC composition if the waiting period is too long. In addition, the article-forming material needs to remain sufficiently molten both to allow for sufficient adhesion between the IMC and the substrate as well as to provide sufficient compressability to allow adequate flow of the IMC around the surface of the substrate (i.e. article) in the mold. Thus, the ease of coating injection needs to be balanced with the need for sufficient residual heat to obtain an adequate curing of the IMC composition.

After the first composition has been injected into mold cavity 16 and the surface of the molded article to be coated has cooled below the melt point or otherwise reached a temperature or modulus sufficient to accept or support a coating composition but before the surface has cooled so much that curing of the IMC composition is inhibited, a predetermined amount of an IMC composition is ready to be introduced into the mold cavity from orifice 40 (FIG. 2) of second composition injector 32.

The point in the molding process when the IMC composition is injected, hereinafter referred to as T_{IMC}, can be characterized as an elapsed time from T₀. For the second injector 32 to inject the IMC composition precisely at T_{IMC} control apparatus 80 must perform several functions at precise times between T₀ and T_{IMC}. Each of these functions occurs at a predetermined elapsed time relative to T₀. One such function is filling metering cylinder 84 with a desired amount of IMC composition. This function occurs in advance of T_{IMC}. Thus, at the preselected elapsed time, control apparatus 80 opens a valve (not shown) that permits fluid communication between the IMC-composition-filled container and metering cylinder 84. Transfer pump 86 then pumps coating composition from the container to metering cylinder 84. When metering cylinder 84 is filled a desired amount, the valve closes to prevent more IMC from entering cylinder 84. The amount of IMC composition permitted to enter cylinder 84 is selectively adjustable.

After cylinder 84 is filled and just prior to T_{IMC}, control apparatus 80 opens a pin or valve (not shown) on second injector 32 to allow fluid communication between second injector 32 and mold cavity 16. The valve is normally biased or urged toward a closed position, i.e., flush to the mold surface, but is selectively movable toward the open position by control apparatus 80. Specifically, for example, an electrically powered hydraulic pump (not shown) of control apparatus 80 is used to move the valve. Immediately or very shortly thereafter, at T_{IMC}, the hydraulic means of cylinder 84 evacuates the IMC composition contained therein and delivers it to second injector 32 where it passes through orifice 40 and into mold cavity 16.

The IMC composition is injected into the mold cavity at a pressure ranging generally from about 3.5 to about 35 MPa, desirably from about 10 to about 31 MPa, and preferably from about 13.5 to about 28 MPa.

Once coating composition has been injected into mold cavity 16, second injector 32 is deactivated, thus causing flow of coating composition to cease. The coating composition flows around the molded article and adheres to its surface. Curing or crosslinking of the coating composition can be caused by the residual heat of the substrate and/or mold halves or by reaction of the composition components. The curing coating composition adheres to the substrate surface, thus forming a coating thereon. If the residual heat of the substrate is used to effect curing, the IMC composition is injected before the molded article has cooled to the point below where proper curing of the coating can be achieved. The IMC composition requires a minimum temperature to activate the catalyst or initiator present therein which causes a cross-linking reaction to occur, thereby curing and bonding the coating to the substrate.

As detailed above, the IMC composition preferably is injected soon after the surface of the molded article has cooled enough to reach its melt temperature. The determination of when the melt temperature is reached can be determined from time elapsed from T₀ based on results from previous trials using the same materials and mold conditions. Alternatively, if a temperature sensor is used with or in place of the transmitter, the point at which the molding resin reaches its melt temperature can be determined directly by observation of the internal mold temperature if the melt temperature of a particular resin is known. Finally, this point can also be determined indirectly by observation of the internal mold pressure. As noted, when the molded part cools to its melt temperature and begins to solidify, it contracts somewhat, thus reducing the pressure in the mold, which may recorded through the use of a pressure transducer (not shown) in the mold.

In the above described process, the mold is generally not opened or unclamped before the IMC is applied. That is, the mold halves maintain a parting line and generally remain substantially fixed relative to each other while both the first and second compositions are injected into the mold cavity. The IMC composition spreads out from the mold surface and coats a predetermined portion or area of the molded article. Immediately or very shortly after the IMC composition is fully injected into mold cavity 16, the nozzle valve or deactivation means of second injector 32 is engaged, thereby preventing further injection of IMC composition into mold cavity 16.

IMCs are generally flexible and can be utilized on a variety of injection molded substrates, including thermoplastics and thermosets. Thermoplastic molding resins which can be used to make articles capable of being coated by means of the foregoing composition include acrylonitrile-butadiene-styrene (ABS), phenolics, polycarbonate (PC), thermoplastic polyesters, polyolefins including polyolefin copolymers and polyolefin blends, PVC, epoxies, silicones, and similar thermoplastic resins, as well as alloys of such molding resins. Preferred thermoplastic resins include PC and PC alloys, ABS, and alloy mixtures of PC/ABS. Useful alloy mixtures of PC/ABS ordinarily have a PC/ABS weight ratio of about 20/80.

Between IMC injections, control apparatus 80 uses transfer pump 86 to circulate IMC composition through the system. The valve on second injector 32 remains in its closed position thereby preventing any IMC composition from entering mold cavity 16. One purpose of circulating the IMC composition between cycles is to prevent any particular portion of the coating composition from becoming undesirably heated due to its proximity to heating mechanisms on molding apparatus 10. Such heating could detrimentally impact the material properties of the IMC or could solidify the IMC composition in the fluid lines.

Controls 96 and keypad 98 of control apparatus 80 enable an operator to adjust and/or set certain operating parameters of control apparatus 80. For example, the controls can be manipulated to increase or decrease the amount of IMC composition to be filled in cylinder 84 by allowing the valve that controls communication between cylinder 84 and receiving container 82 to remain open for a longer duration. Additionally, the controls can be manipulated to adjust the elapsed time from T₀ that cylinder 84 is filled by transfer pump 86 and/or the amount of time elapsed from T₀ that cylinder 84 is emptied by the hydraulic means. This time may be adjusted to more closely approximate T_{IMC}.

In an alterative embodiment, and as mentioned above, the sensor is a pressure transducer mounted adjacent mold cavity 16 and adapted to record a pressure in mold cavity 16. In this embodiment, the transmitter and timer of control apparatus 80 can be eliminated. Rather than using the time elapsed from T₀ to dictate when the mold processes are begun, in this embodiment control apparatus 80 injects IMC composition into mold cavity 16 based on the pressure recorded in mold cavity 16 by the pressure transducer sensor. The IMC composition is desirably injected into the mold cavity at the same point in the molding process, T_{IMC}, irrespective of what type of sensor is used. Thus, rather than being time dependent, this embodiment is pressure dependent.

Such control is possible because pressure in mold cavity 16 initially rises as molding resin fills mold cavity. The pressure rises more as the mold cavity is packed. Finally, the pressure in mold cavity 16 begins to decrease as the molded article cools and begins to solidify. At a predetermined pressure during the cooling phase that corresponds with T_{IMC}, the IMC composition is preferably injected into mold cavity 16. The predetermined pressure is generally based on the specific type of resin used and may also be based on the specific type of IMC composition used.

Based on pressure measurements taken by the pressure transducer sensor, the series of functions performed by control apparatus 80 also can be dependent on the pressure measured in mold cavity 16. Thus, each of the functions can occur at a predetermined pressure in mold cavity 16 so that the IMC composition can be injected into mold cavity 16 at the desired point in the molding process. Injecting IMC composition into mold cavity 16 onto the surface of a molded article based on the pressure measured in the mold cavity is generally described in commonly owned U.S. Pat. No. 6,617,033.

The term “transducer” is meant to cover any type of sensor or other means for measuring or recording a value for an associated variable. Thus, a pressure transducer alternatively can be a plurality of pressure sensors positioned at varying locations around mold cavity 16. In this arrangement, control apparatus 80 would perform its functions, including injecting the IMC composition, based on a plurality of pressure measurements. For example, control apparatus 80 could perform its functions based on predetermined averages of the plurality of pressure measurements taken by the sensors. This arrangement may be desirable because a plurality of pressure transducers may be able to better determine the actual pressure observed in mold cavity 16.

Alternatively or in addition to the previous embodiments, a temperature sensor can be used to determine when to inject the IMC composition. That is, once the temperature mold cavity 16 reaches a temperature below the known melt temperature of the material being used, the IMC composition can be injected.

Various parameters are controlled in the above-described process to produce a final part having acceptable appearance and performance. These include, without limitation, the amount of IMC composition to be injected into the cavity, the precise timing of when to inject the IMC composition into the cavity in relation to the molding process, the force (clamping pressure) necessary to avoid leakage, the injection point of the IMC composition to minimize trapped air and ensure adequate flow over the substrate. In addition, the determination of the optimum operating variables in the molding of each new resin/coating composition combination used in the molding process often requires different values for each of these variables to produce acceptable parts. Such a determination often proceeds on a trial and error basis. While an experienced technician may have some idea as to what is required, he must nonetheless be prepared to generate a certain amount of scrap with any new set up. For example, choices must be made for several variables including, for example, resin temperature, screw temperature, mold temperature, injection pressure, clamping pressure, injection speed, fill time, etc.

In an IMC system, determination of the ultimate machine conditions for use in a given machine using a specific mold, specific substrate material, and specific IMC composition is important. In setting up the IMC assembly, a number of variables must be interrelated to produce acceptable parts in a minimum amount of time. Pressure, times, and other settings of the injection machine vary with the configuration of the mold (i.e. the shape of the part being manufactured) and the polymeric materials being used for the substrate and the coating. To optimize these and other critical operating parameters of the process, a series of experiments with the mold and the specific polymeric materials need to be m.

The present invention provides a quality assurance method for use in an IMC process for enhancing and optimizing the coated article produced thereby. In an embodiment outlined in the flowchart shown in FIG. 4, parts are initially made 100 with a specific resin and coating composition using process conditions derived from “best guess” estimates or extrapolated data from different IMC systems utilizing different molds and/or resin coating composition combinations. For example, the amount of resin in the initial charge can be estimated by first calculating the volume of the mold to be used. Based on this calculation and the known density of the polymer(s), the size of the charge can be approximated.

Finished parts made using these conditions are inspected 102 upon being ejected from the mold and correlated 104 to data collected from the temperature, time and pressure sensors associated with the molding and injection process used to make that particular part. If the part meets all the quality control tests, then no adjustment of process conditions needs to be made and manufacturing of the parts can continue using initial parameter settings 106. If the part fails to meet certain quality control requirements 106 by exhibiting characteristics such as lack of adhesion the coating to the substrate, lack of scratch resistance, surface imperfections, lack of adequate coating coverage, failure of the resin to form the complete shape of the mold cavity, etc., the present parameters, whether time-, temperature-, or pressure-dependent can be adjusted to improve the coating characteristics of future coated parts.

Depending on the defects or imperfections identified with the finished coated article, various process parameters associated with injection of the resin and/or the IMC composition may need to be adjusted. First, the formation of the uncoated part, i.e., the molded substrate, may need to be optimized 108. For example, if the finished part exhibits voids or inadequate filling of the entire mold, the volume of injected resin, injection temperature and/or the pressure at which it is injected or packed into the mold can be increased 110. The amount of resin may need to be increased if voids or inadequate filling of large mold parts are found. If the resin fails to adequately flow into small areas of the mold (e.g. acute angle corners), the injection and/or packing pressure may need to be increased. If the pressure is increased, the clamping pressure on the mold likewise may need to be increased to prevent seepage of the resin out of the mold during the process as discussed above. Differing process variables are tried until an optimal, complete filling of the mold in a minimum time is accomplished. Preferably in these trials, and as discussed above, the mold is fitted with transducers which measure pressure and/or temperature as various process variables, e.g., injection speeds and pressures are altered.

A series of experiments were run using a modified 771 Mg (850 ton) Cincinnati Milacron™ hydraulic clamp injection molding machine to determine the optimal machine settings in the molding of different thermoplastic substrate materials. The substrate materials and the process settings found to yield optimum results are set out in Table 1. As mentioned above, these settings were arrived at by the process described using a bracketing procedure. The mold used in these trials resembles a valve cover for an automobile engine essentially having the shape of an open box with turned down sides.

These results might not necessarily be applicable to another molding machine. Rather, a new series of tests might be necessary based on the system to be modified. This is also true in the case of a different mold or resin. In such a case, similar tests would need to be run to find optimum operating parameters.

Example 1 was run using IMPET™ EKX215 glass-filled polyester (Ticona) as the molding resin. Example 2 was run using IMPET™ EKX230 glass-filled polyester (Ticona) as the molding resin. Example 3 was run using FORTRON™ 4184L6 polyphenylene sulfide (Ticona) as the molding resin.

TABLE 1
Molding of Various Thermoplastics

| | Ex. 1 | Ex. 2 | Ex. 3 |
|---|---|---|---|
| Machine Set-points | | | |
| Nozzle (° C.) | 261 | 261 | 304 |
| Barrel Temp., Zones | 265, 266, | 265, 266, | 314, 309, |
| A-D (° C.) | 266, 509 | 266, 265 | 308, 303 |
| Mold Temp., Zones | 260, 260, | 260, 260, | 304, 304, |
| 1-8 (° C.) | 149, 260, | 149, 260, | 149, 304, |
| | 149, 260, | 149, 260, | 149, 304, |
| | 260, 260 | 260, 260 | 304, 316 |
| Stationary Mold Temp. | 117 | 117 | 133 |
| (° C.) | | | |
| Moving Mold Temp. (° C.) | 135 | 135 | 147 |
| Injection High, Pack, Hold | 10.0, 4.0, | 10.0, 4.0, | 10.0, 3.0, |
| (sec) | 4.0 | 4.0 | 2.0 |
| Cooling (sec) | 90.0 | 60.0 | 60.0 |
| Clamp Open (sec) | 0.0 | 0.0 | 0.0 |
| Ejector forward dwell (sec) | 0.99 | 0.0 | 0.0 |
| Extruder delay (sec) | 0.0 | 0.0 | 0.0 |
| Core Set (Sec) | 0.8 | 0.8 | 0.8 |
| Injection high pressure | 15.2 | 15.2 | 15.2 |
| limit (MPa) | | | |
| Injection Pack pressure | 6.9, 6.9 | 7.6, 7.6 | 5.5, 5.5 |
| 1, 2 (MPa) | | | |
| Injection Hold pressure | 6.2, 6.2 | 6.2, 6.2 | 4.8, 4.8 |
| 1, 2 (MPa) | | | |
| Shot size (cm) | 7.87 | 7.75 | 6.86 |
| Transfer position (cm) | 3.56 | 1.78 | 3.05 |
| Decompression before, | 0, 0.76 | 0, 0.76 | 0, 0.76 |
| after (cm) | | | |
| Injection Profile | | | |
| (Speed, % of shot size) | | | |
| Seq. 1 | 1.25, 80 | 1.25, 80 | 1.00, 80 |
| Seq. 2 | 1.10, 60 | 1.10, 60 | 1.00, 60 |
| Seq. 3 | 1.00, 40 | 1.00, 40 | 1.00, 40 |
| Seq. 4 | 1.00, 20 | 0.60, 20 | 1.00, 20 |
| Seq. 5 | 0.60, X-FER | 0.60, X-FER | 0.60, X-FER |

Having determined the optimum operating parameters for production of the thermoplastic substrate, one may then need to optimize the IMC process 112 to form the finished article. If the IMC exhibits adequate coverage, appearance and adhesion, then no further modification needs to be done and manufacturing of the parts under the previous conditions may proceed 114.

If the coating fails to pass quality control tests, the process parameters can be adjusted. Two problems that can occur with the coating of the substrates are intermingling of the IMC composition with the substrate-forming composition, which can result in poor surface appearance, and poor adhesion of the IMC to the substrate. Intermingling typically is caused by premature injection of the IMC composition into the mold before the surface sufficiently cools to begin hardening; poor adhesion typically is caused by injecting the IMC composition too late after the resin begins cooling, such that there is not enough residual heat to cure the IMC composition sufficiently and/or bond it to the surface of the substrate.

As detailed above, the IMC should be injected soon after the surface of the substrate has cooled enough for its constituent material(s) to be below its melt temperature. The exact time at which the substrate forming material has reached this temperature can be determined in several ways, as detailed above. Using a temperature sensor, as explained above, it is possible to determine when the melt temperature is reached by comparing the measured value with the known melt temperature, as determined from previous experiment or from reported literature values. Alternatively the point at which the melt temperature is reached can be determined indirectly by observation of the internal mold pressure. When the molded part reaches its melt temperature and begins to solidify, it contracts somewhat, thus reducing the pressure in the mold, which is recorded through the use of pressure transducers in the mold. Finally, if no transducers are used in the production runs, the time when the melt temperature is reached and injection of IMC composition commences can be determined using pilot runs and then this time can be varied to perfect the resulting final coated parts. Thus, to improve the IMC process, adjustments can be made by altering the time, pressure or temperature at which the IMC composition is injected or the amount of cure time allowed prior to opening the mold after injection 116.

Some conventional injection molding machines and molds are already equipped with one or more pressure transducers adapted to measure resistance of the mold clamping mechanisms to mold opening created by injection of resin into the mold. These machines are often capable of sending the measured pressure or pressures to associated equipment such as control apparatus 80 through conventional data transfer means. In this case, the need for a remote pressure transducer sensor of the control apparatus can be eliminated. The control apparatus need only be connected to injection molding machine 10 to receive pressure measurements taken from mold cavity 16.

A series of experiments using a modified Toshiba™ 950 injection molding machine and hydraulic clamp were conducted. In a first set of experiments, conducted using IMPET™ glass filled polyester (Ticona; Summit, N.J.) as the resin and STYLECOAT™ primer acrylic thermoset (OMNOVA Solutions Inc.; Fairlawn, Ohio) as the IMC, the IMPET™ substrate was determined to have cooled sufficiently below its melt point 50 seconds after the mold had closed. Three parts were run using a cure time for the IMC of 90 seconds before opening the mold. These parts showed good coating and appearance. A further 33 parts were run using these settings to confirm good appearance and good adhesion of the IMC to the thermoplastic. Further samples were run injecting the IMC only 30 seconds after the mold had closed and using a cure time of only 60 seconds. This part was unacceptable as the IMC had intermingled with the polyester and failed to sufficiently coat the part.

Another series of test were run using VANDAR™ AB700 thermoplastic polyester (Ticona) as the thermoplastic and STYLECOAT™ acrylic thermoset (OMNOVA Solutions) as the IMC. The cure time was held at 160 seconds while varying the time after mold closing at which the IMC composition was injected. The results are shown in Table 2.

TABLE 2
Results of IMC Process Optimization Trials

| | Delay after | | |
|---|---|---|---|
| No. of | mold is | Cure time | |
| parts | closed (sec) | (sec.) | Comments |
| 5 | 10 | 160 | Poor appearance, coating |
| | | | intermingled with substrate |
| 5 | 15 | 160 | Poor appearance, coating |
| | | | intermingled with substrate |
| 5 | 25 | 160 | Poor appearance, coating |
| | | | intermingled with substrate |
| 5 | 40 | 160 | Good appearance, extended cure |
| | | | time for center of parts to have |
| | | | good cure |
| 5 | 100 | 160 | Poor appearance, poor adhesion or |
| | | | coverage of coating to part |
| 5 | 120 | 160 | Poor appearance, poor adhesion or |
| | | | coverage of coating to part |

Injection started 10 seconds after the mold was closed and the polyester was injected. The IMC composition was found to intermingle with the thermoplastic to produce parts having an unacceptable appearance. The delay before IMC composition injection was then set to 120 seconds. Parts from these trials were unacceptable due to poor adhesion and coverage. Various intermediate times were then tried using a bracketing procedure until a time of 40 seconds produced parts having an acceptable appearance and adhesion.

After the modifications to the thermoplastic molding and the IMC are performed, additional parts are made using these modified processes and the new parts are inspected 118 for quality control purposes. If the parts again fail to meet QC standards, the process is started again with a determination of whether the thermoplastic molding needs to be modified. Once the thermoplastic molding and IMC operating parameters are optimized, the specific values for these parameters can be relayed 120 to the dispense and control apparatus to ensure quality parts are produced during subsequent processing runs.

The above examples demonstrate the effectiveness of the present invention in optimizing the molding assembly so as to ensure the IMC is injected under such conditions so as to ensure parts meeting appearance and adhesion standards.

In another alternative embodiment, the relayed operating parameters are forwarded to a data collection means operatively associated with dispense and control apparatus 80. The data collection means can be an on-board hard drive or other recording medium capable of recording the operating parameters set on the control apparatus for one or a series of molded articles. For example, the data collection means can record the predetermined elapsed time settings from T₀ that the various control apparatus functions are set to use and/or the actual elapsed time intervals when the various functions occur.

For example, for each injection of IMC composition, the data collection means could record the time from To that transfer pump 86 fills metering cylinder 84, the time from T₀ that the valve of second injector 32 opens, the time from T₀ that the hydraulic means evacuates metering cylinder 84 and second injector 32 injects the IMC composition into the cavity and/or the time from T₀ that the valve of the second injector closes. Of course other functions also can be recorded including without limitation, the number of IMC composition injections for a specific amount of coating composition, the hydraulic pressure used to evacuate metering cylinder 84, etc.

If one or more pressure transducers are used in place of the transmitter (a time dependent sensor), the data collection means can be used to record related measurements. For example, the data collection means can record specific measured pressures at which time functions of the control apparatus occur.

In any case, the data or information recorded by the data collection means can be used for quality control purposes. For example, a specific in-mold coated part can be examined upon being ejected from the mold cavity and compared against the data collected on the specific injection of IMC composition associated with that particular part. If the part does not meet certain quality control requirements such as lack of adhesion between the coating and the substrate, lack of scratch resistance, surface imperfections, lack of adequate coating coverage, etc., the present parameters, whether time, temperature, or pressure dependent, can be adjusted as detailed above to improve the coating characteristics of future coated parts.

The control apparatus can also be equipped with a means for transferring collected data. This could be through any conventional means including providing a disk drive or the like that allows data to be recorded to a mobile storage medium, providing a data link connectable to a local computer, an intranet, the internet, etc. Such means for transferring data can allow remote analysis of collected data in real-time.

To ease the correlation between the operating parameters and the parts produced using the stated parameters, control apparatus 80 may include, e.g., a conventional bar code reader (not shown) or other electronic identification means. The bar code reader can be used to scan a bar code on a particular container of IMC composition placed in receiving cylinder 82 and injected onto a plurality of molded parts. Used in conjunction with the data collection means described above, the bar code for a particular container of IMC composition can be associated with data recorded for all injections of IMC composition from the particular container. Further, the bar code of the container can be associated with a finished parts bin or collection means that receives finished parts with a coating thereon from the molding apparatus. Recording and storing such information allows particular finished parts to be analyzed and easily compared against the data recorded thereabout and the particular IMC composition used. This in turn allows for a more effective quality control of produced parts.

To more quickly and easily optimize the parts produced using the present quality assurance method, the control apparatus may be provided with a user interface that allows a user to simply select a part icon that represents a series of parts to be molded and coated. Selection of a specific part icon on the user interface presets the control parameters previously optimized as described above on the control apparatus whether they are time-based, mold pressure based, or otherwise. The user interface eliminates the need for an operator to set the control parameters individually each time a new part series is to be run through the molding and coating process.

In any of the embodiments discussed herein, control apparatus 80 can be provided with a display means such as a monitor (not shown), which can display, in real time, any of the data or information being sensed and/or recorded by the control apparatus.

What is claimed is:

1. A method for assuring that coated molded articles meet predetermined quality standards, said articles being formed entirely in a mold by a process that includes forming a substrate from a first composition using a first set of process conditions and subsequently, using a second set of process conditions, coating said substrate by injecting a coating composition into said mold and allowing said coating composition to cure on said substrate so as to provide a coated molded article, said method comprising:
a) Inspecting a first coated molded article manufactured by the process after said article is removed from said mold;
b) determining whether said coated molded article meets quality standards for substrate formation and, if the article does not meet such standards, modifying the substrate formation step of the process by adjusting one or more of first composition injection volume, first composition Injection temperature, first composition injection pressure, and substrate molding pressure; and
c) determining whether said coated molded article meets quality standards for coating and, if the article does not meet such standards, modifying the coating step of the process by adjusting one or more of cure time, injection time, injection pressure, injection volume, injection temperature, and mold temperature at injection of said coating composition, and
wherein the determination of step (c) comprises determining (i) whether said coating is intermingled with said substrate, (ii) whether a surface appearance of said coating is acceptable, and (iii) whether said coating is sufficiently adhered to said article, said mold optionally having a constant volume maintained throughout the process

2. The method of claim 1 wherein the determination of step (b) comprises evaluating whether said article exhibits at least one voids and inadequate filling of said mold by said first composition.

3. The method of any of claims 1 to 2 wherein said first set of process conditions includes one or more injection pressures for said first composition, one or more injection temperatures for said first composition, one or more injection volumes for said first composition, one or more injection times for said coating composition, one or more injection pressures for said coating compositions, one or more injection volumes for said coating composition, and one or more cure times for said coating composition.

4. The method of any of claims 1 to 3 wherein said coating composition is injected into said mold after said substrate has cooled to a point where said first composition Is below Its melt temperature.

5. The method of claim 4 wherein said point is determined by monitoring in said mold at least one of a temperature and an internal pressure.

6. The method of any of claims 1 to 5 wherein the modification of step (c) is performed by adjusting at least one of a time at which said coating composition is injected into said mold relative to a time at which the substrate formation step of the molding process is begun, a time at which said mold is opened and the coated article is removed from said mold relative to a time at which said coating composition is injected in said mold, and an injection pressure for said coating composition.

7. The method of any of claims 1 to 6 wherein values for one or more of said process conditions for the substrate formation and coating steps are controlled and recorded by a control apparatus operatively associated with said mold.

8. The method of any claims 1 to 7 wherein steps (a) through (c) are performed repeatedly, until a coated article that meets said quality standards is produced.

9. The method of any of claims 1 to 8 wherein the process conditions used to create the coated article meeting said quality standards are stored in a control apparatus associated with said mold such that said process conditions can be recalled for use in future molding operations.
